(19) United States
(12) Patent Application Publication
(10) Pub. No.: US 2017/0051715 A1
(43) Pub. Date: Feb. 23, 2017

(54) FUEL RAIL FOR AN INTERNAL COMBUSTION ENGINE

(71) Applicant: Hitachi Automotive Systems Americas Inc., Harrodsburg, KY (US)

(72) Inventors: Donald J. McCune, Farmington Hills, MI (US); Prashanth Avireddi, Farmington Hills, MI (US)

(21) Appl. No.: 14/830,334

(22) Filed: Aug. 19, 2015

(51) Int. Cl. F02M 63/02; F02M 59/10

(52) U.S. Cl. CPC F02M 63/0265; F02M 59/102

(57) ABSTRACT

A fuel rail for a direct injection engine. The fuel rail includes an elongated tubular housing which defines an elongated main chamber. An elongated tube is disposed in the main chamber of the housing and defines an inlet chamber inside of the tube and an annular outlet chamber between the housing and the tube. The tube has a fuel inlet open to its inlet chamber and adapted for connection with a fuel pump. At least two orifices are formed through the tube which fluidly connects the inlet chamber with the outlet chamber. The orifices are positioned and sized to minimize fuel pressure gradients in the fuel rail caused by fuel injection by the fuel injectors.

### BACKGROUND OF THE INVENTION

I. Field of the Invention

The present invention relates to a fuel rail for an internal combustion engine.

II. Description of Related Art

The use of SIDI (spark ignition by direct injection) internal combustion engines in the automotive industry has enjoyed increased popularity. The increased popularity and use of SIDI engines in the automotive industry results primarily from better fuel economy and more efficient operation of the engine.

As shown in FIG 8, in a conventional fuel system 100 for a SIDI engine, a fuel pump 102 has its inlet 104 connected to a fuel source 106, usually the fuel tank, and its outlet 108 connected to one or more fuel rails 110 that are disposed adjacent the fuel combustion chambers of the engine. A fuel injector 112 is associated with each combustion chamber for the engine and these fuel injectors 112 are fluidly connected to the fuel rail 110. Thus, in the normal operation, the pump 102 supplies fuel to the fuel rails 110 which, in turn, supply fuel to the fuel injectors 112.

As shown in FIGS. 8 and 9, a plunger type fuel pump 102 is typically used to supply fuel from the fuel tank 106 and to the fuel rails 110. These previously known fuel pumps 102 include a housing 114 defining an interior pump chamber 116. A plunger 118 is then reciprocally driven within the pump chamber 116 by a cam 120 having one and typically more lobes 122.

An inlet valve 124, often actuated by a solenoid 126, is fluidly connected in series between the fuel tank 106 and the pump chamber 116 while a one-way outlet valve 128 is fluidly connected in series between the pump chamber 116 and the fuel rail 110. Thus, as the plunger 118 is retracted from the pump chamber 116, the inlet valve 124 is open which allows the plunger 118 to induct fuel from the fuel tank 106 into the pump chamber 116. The inlet valve 124 then closes so that during the subsequent pump or compression stroke of the plunger 118, the plunger 118 pumps pressurized fuel past the one-way outlet valve 128 at the pump outlet and to the fuel rails 110. In this fashion, the pump 102 continuously supplies pressurized fuel to the fuel rails 110 for subsequent supply to the fuel injectors 112.

Since these previously known SIDI engines utilize a plunger fuel pump, the outlet 108 from the fuel pump 102 is subject to severe pressure pulsations due to the reciprocating behavior of the plunger. These fuel pulsations, furthermore, depend upon the engine speed which, in turn, controls the rotational speed of the cam 120 which actuates the plunger 118, but is typically in the order of milliseconds at low engine speeds. These pressure pulsations are conveyed to the fuel rail or rails which supply the fuel to the fuel injectors.

The fuel pulsations in the fuel system for the SIDI engine can create substantial noise in the fuel system, especially at low engine speeds. Indeed, the pressure pulsations from the fuel pump are not only conveyed to the fuel rails, but these pulsations are reflected between the ends of the fuel rail thus producing pressure variances longitudinally along the fuel rail.

In addition to the pressure variations in the fuel rail caused by pressure pulsations from the fuel pump, fuel pressure gradients also occur within the fuel rail which result from fuel injection from the individual fuel injectors. In particular upon a fuel injection from one fuel injector, the fuel pressure in the fuel rail at the connection of the fuel injector with the fuel rail is immediately reduced. This, in turn, causes a pressure gradient in the fuel rail so that the instantaneous fuel pressure available at the point of connection of the fuel injectors with the fuel rails varies between the different fuel injectors. This difference in fuel pressure in turn results in a different fuel quantity injected into the engine by the different fuel injectors. Such an uneven quantity of fuel injection into the different cylinders for the SIDI engine results in decreased engine efficiency and reduced fuel economy.

While there have been many previously known devices directed to reducing pressure pulsations within the fuel rail in an attempt to reduce noise from the fuel system, none of these prior art devices have addressed the issue of non-uniform fuel injection into the engine combustion chambers by the different fuel injectors.

### SUMMARY OF THE PRESENT INVENTION

The present invention provides a fuel rail for a liquid fuel internal combustion engine having multiple fuel injectors which minimizes the pressure variations within the fuel rail between the different fuel injectors.

In brief, the present invention includes an elongated tubular housing, preferably cylindrical in cross-sectional shape, which defines an elongated main chamber. The housing is constructed of any suitable rigid material, such as stainless steel.

An elongated tube is disposed within the main chamber of the housing. Upon doing so, the tube divides the main chamber into a cylindrical inlet chamber inside the tube as well as an annular outlet chamber between the housing and the tube. Furthermore, the tube includes a fuel rail fuel inlet which is fluidly connected to the pressurized fuel outlet from the fuel pump.

At least two orifices are formed through the tube which fluidly connects the inlet chamber with the outlet chamber. These orifices are independent in size from each other and may take any of several different shapes, but preferably the cross-sectional area of the combined orifices is equal to or slightly larger than the area of the injector orifice area.

The fuel injectors for the engine are fluidly connected to the housing in the conventional fashion so that the fuel injector ports in the housing are longitudinally spaced from each other. These fuel injector ports are thus in fluid communication with the annular outlet chamber in the housing.

The position of the orifice or orifices formed through the tube and thus fluidly connecting the inlet chamber with the outlet chamber is preferably empirically determined to minimize the pressure variations caused by the pump pulsations between the injector ports. By thus equalizing, or nearly equalizing the pressure within the annular outlet chamber at each fuel injector port, the quantity of fuel injected by each fuel injector will be substantially the same. In doing so, the overall fuel economy and engine efficiency is improved.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a fuel system for a liquid fuel internal combustion engine;

FIG. 2 is a longitudinal sectional view illustrating a fuel rail 20 according to the present invention;

FIG. 3 is a sectional view taken substantially along line 3-3 in FIG. 2;

FIG. 4 is a prior art graph showing fuel injection rates for three different fuel injectors;

FIG. 5 is a view similar to FIG. 4, but illustrating the fuel injection rates for a fuel rail in accordance with the present invention;

FIG. 6 is a fragmentary sectional view of one end of the fuel rail and illustrating one mode of manufacture of the fuel rail;

FIG. 7 is a sectional elevational view of the fuel rail;

FIG. 8 is an devotional view of a prior at fuel system; and

FIG. 9 is a sectional view of a prior art SIDI fuel pump.

### DETAILED DESCRIPTION OF A PREFERRED EMBODIMENT OF THE PRESENT INVENTION

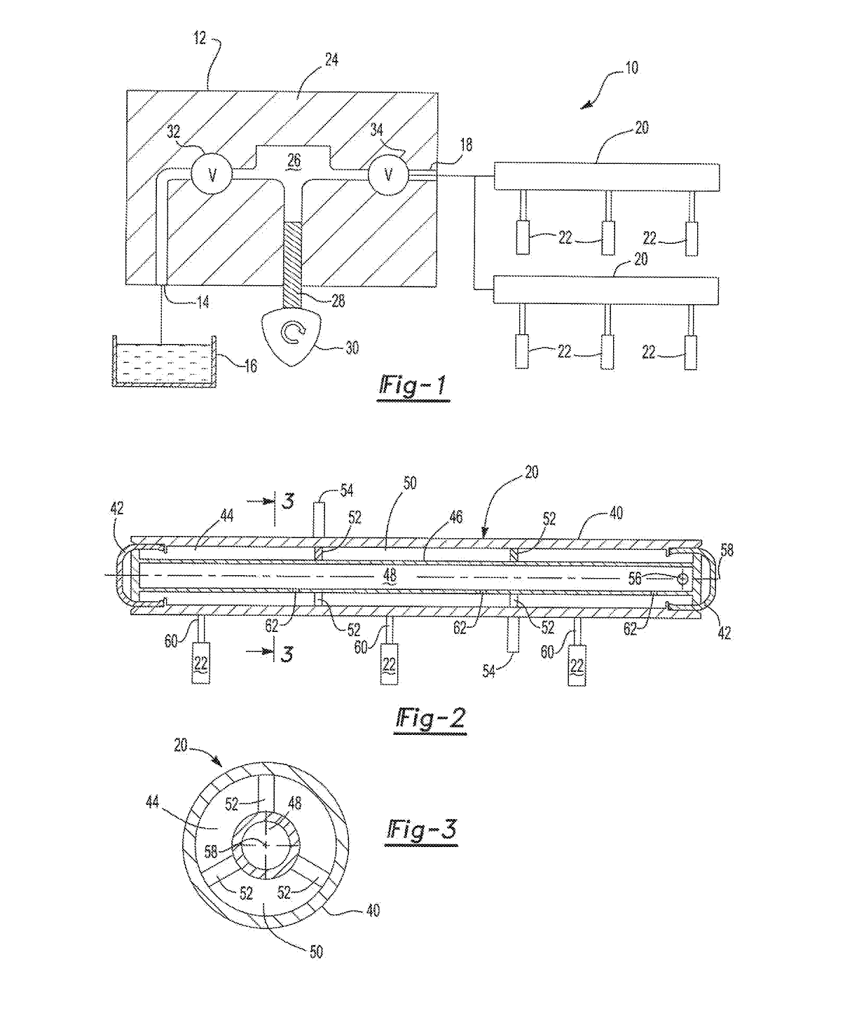

With reference first to FIG. 1, a fuel system 10 for a liquid fuel internal combustion engine, such as a spark ignition direct injection engine, is illustrated. The fuel system 10 includes a fuel pump 12 (illustrated diagrammatically) having its inlet 14 fluidly connected to a fuel source 16, such as the fuel tank.. An outlet 18 from the fuel pump 12 is fluidly connected to one or more elongated fuel rails 20. Each fuel rail 20, furthermore, supplies fuel to two or more fuel injectors 22.

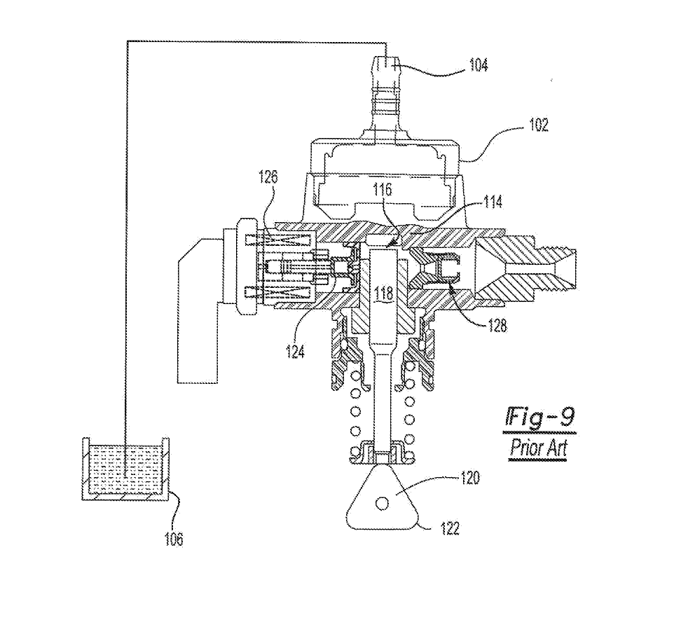

The fuel pump 12 is of conventional construction, such as illustrated in FIG. 9, and includes a housing 24 defining a pump chamber 26. A plunger 28 is reciprocally mounted within the pump chamber 26 and is reciprocally driven by a cam 30.

The pump inlet 14 is connected through an inlet valve 32, which may be solenoid actuated, to the pump chamber 26. A one-way outlet check valve 34 is fluidly connected in series between the pump chamber 26 and the fuel rails 20.

In the well-known fashion, rotation of the cam 30 reciprocally drives the plunger 28 in the pump chamber 26. The valve 32 opens during the down stroke or suction stroke of the piston 28. In doing so, the plunger 28 inducts fuel from the fuel source 16 through the inlet valve 32 and into the pump chamber 26. Conversely, during the compression or pump stroke of the plunger 28, the inlet valve 32 is closed so that pressurized fuel is pumped through the outlet valve 34 to the fuel rails 20. The fuel flow out through the pump outlet 18 necessarily contains the pressure pulsations from the reciprocation of the plunger 28.

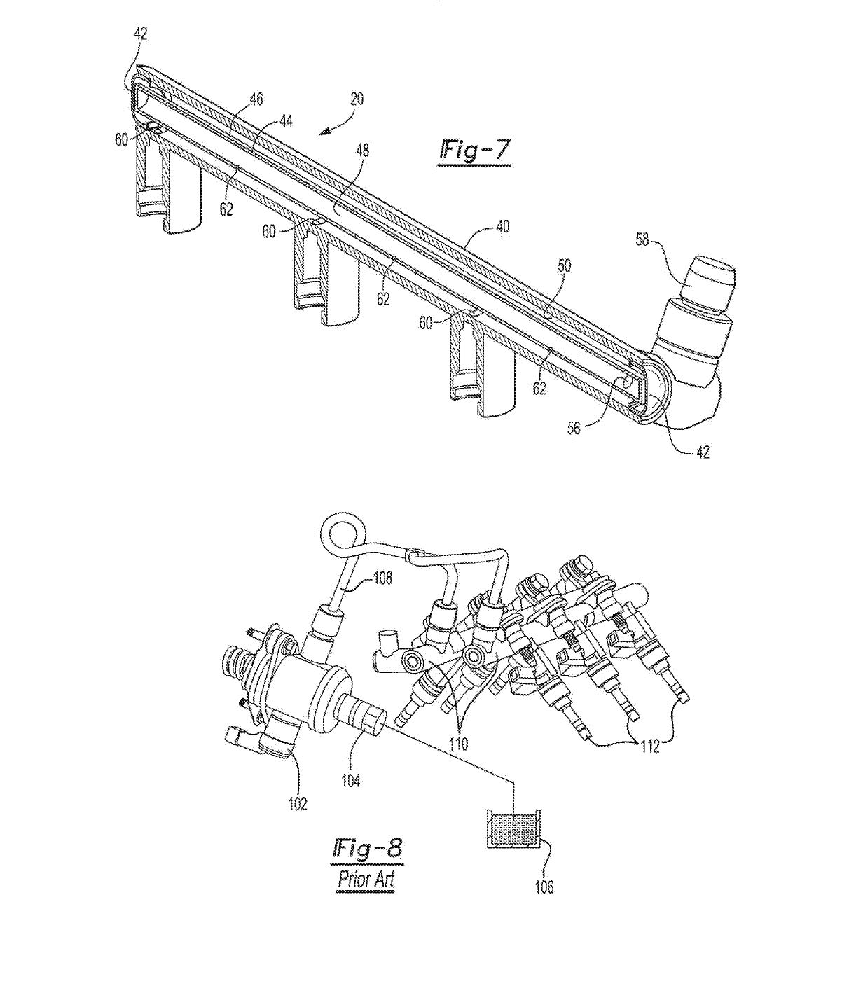

With reference now to FIGS. 2, 3, and 7, one fuel rail 20 is there shown in greater detail. The fuel rail 20 includes an elongated housing 40 which is preferably tubular and cylindrical in shape. The housing 40 is constructed from any rigid material, such as stainless steel, and is closed by a cap 42 at each end. In doing so, the housing 40 together with the caps 42 form an elongated generally cylindrical main chamber 44.

An elongated tube 46 is then disposed coaxially within the housing 40 so that the tube 46 extends between the end caps 42 of the housing 40. The tube 46 is constructed of any suitable rigid material, such as stainless steel, and is preferably tubular and cylindrical in shape. In addition the inside diameter of the tube 46 is at least one half the inside diameter of the housing 40.

The tube 46 thus defines a cylindrical inlet chamber 48 within the interior of the tube 46, as well as a tubular and cylindrical annular chamber 50 defined in between the tube 46 and the housing 40.

In order to maintain the tube 46 coaxial with the housing 40, a plurality of spacers 52 are optionally provided within the annular outlet chamber 50 so that the spacers 52 contact both the inner surface of the housing 40 and outer surface of the tube 46 to mechanically support the tube 46 to the housing 40. However, as best shown in FIG. 3, the spacers 52 are circumferentially spaced from each other and permit free fluid flow longitudinally through the annular outlet chamber 50.

Still referring to FIGS. 2 and 3, if additional support is needed for the fuel rail 20, one or more outer supports 54 may be provided between the outer surface of the housing 20 and the internal combustion engine. Preferably, these outer supports 54 me in alignment with the spacers 52 to enhance the rigidity of the overall fuel rail 20.

This fuel inlet 56 is fluidly connected by a fuel line 58 to the pump outlet 18 (FIG. 1).

As best shown in FIG. 2, fuel injector ports 60 are formed through the housing 40 at longitudinally spaced positions along the housing 40. These fuel injector ports 60 are thus in fluid communication with the annular outer chamber 50 formed between the housing 40 and tube 46. These fuel injector ports 60 are directly connected to the fuel injectors 22 and, since the fuel rail 20 is used in conjunction with a SIDI engine, the actual position of the fuel ports 60 is determined by the position of the fuel injectors 22 (see FIG. 1).

At least two orifices 62 are formed through the tube 46 thus fluidly connecting the cylindrical inlet chamber 48 with the annular outlet chamber 50. Consequently, fuel flow into the inlet chamber 48 of the tube 46 passes through the orifices and into the annular outlet chamber 50. From the annular outlet chamber 50, fuel flows to the fuel injectors 22.

The position of the orifices 62 through the tube 46 and the cross-sectional area or size of each orifice 62 is independently selected to minimize pressure gradients or variations within the annular chamber 50 at the point of the injector ports 60 caused by fuel injection by the fuel injectors 22. This position and size for the orifices 62 are independent and may be empirically determined. However, minimization of pressure gradients within the outlet chamber 50 at the points of the injector ports 60 is generally achieved by positioning the orifices 62 intermediate to fuel injectors 22 or, at the end of the tube 46 adjacent the fuel inlet 56, between one fuel injector 22 and the end cap 42 of the fuel rail 20.

In order to prevent fuel restriction of the fuel flow within the fuel rail 20 and yet minimize the pressure gradients in the annular outlet chamber 50 around the injector ports 60, the aggregate cross-sectional area of the orifices 62 is preferably the same as, or slightly larger than, the cross-sectional area of injector orifice 60. Furthermore, the orifices 62 may take many different shapes, such as circular, oval, and the like. In addition, the size of the orifices 62 will be independent of each other. Rather, the orifice sizes on the inner tube are preferably approximately inversely proportional to the average pressure drop across each of the fuel injectors 22 from the inlet 56.

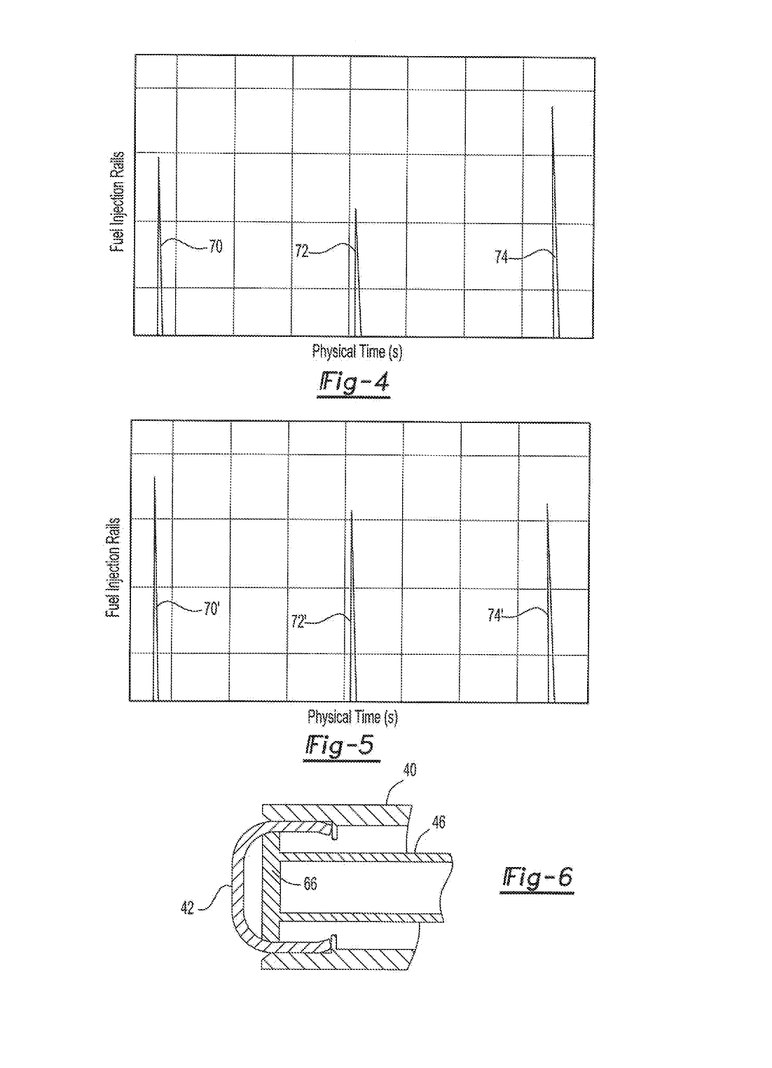

In practice, the minimization of fuel pressure gradients in the chamber 50 of the fuel rail 20 minimizes variations in the fuel delivery quantity of the different fuel injectors 22. For example, as shown in FIG. 4, the fuel injection rate or quantity for three different fuel injectors 22 is illustrated. Specifically, graph 70 illustrates the fuel injection for one fuel injector 22, graph 72 illustrates the fuel injection rate for the adjacent fuel injector 22, and graph 74 illustrates the fuel injection rate for the last fuel injector 22. Significant variations in the fuel injection rate are apparent, especially between graphs 72 and 74.

With reference now to FIG. 5, with the present invention, graphs 70′, 72′, and 74′ illustrate the corresponding fuel injection rates for a fuel rail 20 in accordance with the present invention. As can be seen from FIG. 5, the variation between the fuel rates for the three different injectors is greatly minimized.

Any conventional manufacturing method may be employed to manufacture the fuel rail 20. However, one such method of manufacture is illustrated in FIG. 6 in which the cap 42 is press fit into the housing 40 at each end of the housing 40. The tube 46 includes a cylindrical flange 66 at its end. This flange 66 not only closes the end of the tube 46, but is also press fit into the cap 42 to rigidly fix the tube 46 to the housing 40.

From the foregoing, it can be seen that the present invention provides a fuel rail for a liquid fuel internal combustion engine, and especially for a SIDI engine, which ensures a much more even fuel supply to the different combustion chambers than with the previously known fuel injector rails. Having described our invention, however, many modifications thereto will become apparent to those skilled in the art to which it pertains without deviation from the spirit of the invention as defined by the scope of the appended claims.

We claim:

1. A fuel rail for a liquid fuel injection internal combustion engine having fuel injectors fluidly connected to the rail comprising:
an elongated tubular housing defining an elongated main chamber,
an elongated tube disposed in said main chamber of said housing and defining an inlet chamber inside said tube and an annular outlet chamber between said housing and said tube,
said tube having a fuel inlet open to said inlet chamber,
at least two orifices formed through said tube which fluidly connects said inlet chamber to said outlet chamber, said orifices being positioned and independently sized.

2. The fuel rail as defined in claim 1 and comprising a plurality of longitudinally spaced orifices formed through said tube which fluidly connects said inlet chamber to said outlet chamber.

3. The fuel rail as defined in claim 2 wherein the fuel rail supplies fuel to a fixed number of fuel injectors and wherein said at least one orifice comprises said fixed number of orifices.

4. The fuel rail as defined in claim 3 and comprising said fixed number of longitudinally spaced fuel injector ports formed through said housing and wherein said orifices are positioned intermediate said fuel injector ports or intermediate an end fuel injector port and an end of said housing.

5. The fuel rail as defined in claim 1 and comprising at least one spacer in said outlet chamber which mechanically maintains a spacing between said housing and said tube.

6. The fuel rail as defined in claim 5 and comprising at least one support positioned against an outer surface of said housing in alignment with said at least one spacer.

7. The fuel rail as defined in claim 5 wherein said at least one spacer comprises a plurality of longitudinally spaced spacers.

8. The fuel rail as defined in claim 1 and comprising an end cap attached to and closing each end of said tube, said end cap being press fit or with comparable mounting techniques into said housing.

9. The fuel rail as defined in claim 1 wherein both said housing and said tube are circular in shape and wherein an inside diameter of said tube is at least one half an inside diameter of said housing.

10. The fuel rail as defined in claim 1 wherein the total cross-sectional area of said at least one orifice is substantially the same as a cross-sectional area of said injector orifice.

11. The fuel rail as defined in claim 1 wherein the engine is a direct injection engine.
